(19) United States
(12) Patent Application Publication
(10) Pub. No.: US 2015/0345445 A1
(43) Pub. Date: Dec. 3, 2015

(54) fuel injection system including a fuel-guiding component, a fuel injector, and a connecting element

(71) Applicant: ROBERT BOSCH GMBH, Stuttgart (DE)

(72) Inventors: Wilhelm Reinhardt, Oetisheim (DE); Volker Scheef, Ludwigsburg (DE); Michael Mayer, Wannweil (DE); Andreas Rehwald, Bietigheim-Bissingen (DE); Jan Hermann, Stuttgart (DE); Philipp Rogler, Stuttgart (DE); Andreas Glaser, Stuttgart (DE); Hans-Georg Horst, Leonberg (DE); Martin Riemer, Untergruppenbach (DE); Michael Knorpp, Weissach (DE); Michael Fischer, Niefern-Oeschelbronn (DE)

(73) Assignee: Robert Bosch GmbH, Stuttgart (DE)

(21) Appl. No.: 14/762,003

(22) PCT Filed: Dec. 4, 2013
(86) PCT No.: PCT/EP2013/075485

§ 371 Date: Jul. 20, 2015

(30) Foreign Application Priority Data
Jan. 22, 2013 (DE) 10 2013 200 909.7

(51) Int. Cl. F02M 55/00; F02M 61/16; F16L 27/107; F02M 55/02

(52) U.S. Cl. CPC F02M 55/004; F02M 55/02; F02M 61/167; F16L 27/107

(57) ABSTRACT

A connecting element for connecting a fuel injector of a fuel injection system to a fuel-guiding component includes a base body in which a receiving chamber for a fuel connector of the fuel injector is provided. The fuel connector, which is situated at least partially in the receiving chamber, is supported at least indirectly on the base body. The fuel connector is elastically supported on the base body in a radial direction.

### BACKGROUND OF THE INVENTION

1. Field of the Invention

The present invention relates to a connecting element for fuel injection systems for connecting a fuel injector to a fuel-guiding component, and a fuel injection system which includes such a connecting element. In particular, the present invention relates to the field of fuel injection systems for mixture-compressing, spark ignition internal combustion engines.

2. Description of the Related Art

A fuel injection device is known from published German patent application document DE 10 2005 020 380 A1 which is characterized by a sound-decoupling design. The known fuel injection device includes a fuel injector, a receiving borehole for the fuel injector in a cylinder head of an internal combustion engine, and a fuel distributor line which includes a connecting piece. The fuel injector is introduced into the connecting piece with a partial overlap. In one possible embodiment, a slotted snap ring is provided which engages with a tapered section of an inlet connector of the fuel injector. For this purpose a groove is provided in the connecting piece, in which the snap ring is reliably and securely locked. The snap ring has a conical or concave spherical contact surface for engaging beneath the fuel injector.

The design of the fuel injection device known from published German patent application document DE 10 2005 020 380 A1 has the disadvantage that vibrations may be transmitted from the fuel injector to the connecting piece via the snap ring. This may result in undesirable noise generation.

In particular for electromagnetic high-pressure injectors, which are used in gasoline engines having direct injection, a noticeable, objectionable contribution to the overall noise of the engine, which may be described as “valve ticking,” may result. Such valve ticking results from the rapid opening and closing of the fuel injector, in which the valve needle is moved into the particular end stops with high dynamics. The striking of the valve needle against the end stops results in brief, very high contact forces which are transmitted in the form of structure-borne noise and vibrations to the cylinder head and to a fuel rail via a housing of the fuel injector. This results in excessive noise generation at the cylinder head and at the fuel rail.

### BRIEF SUMMARY OF THE INVENTION

The connecting element and the fuel injection system according to the present invention have the advantage that an improved connection of the fuel injector to the fuel-guiding component is made possible, allowing a reduction in noise. In particular, a soft suspension of the fuel injector on the fuel-guiding component may be achieved in which a significant reduction of the noise generation is achievable.

The connecting element and the fuel injection system are particularly suitable for the direct injection of fuel, in particular gasoline. The fuel-guiding component is preferably designed as a fuel distributor, in particular as a fuel rail. During operation, such a fuel distributor is used for storing fuel which is under high pressure, and for distributing the fuel to multiple fuel injectors. Multiple connecting elements may be provided which are suitably connected to the fuel distributor, or which also represent part of the fuel distributor. During operation, the fuel injectors inject the fuel, which is then under high pressure, necessary for the combustion process into the particular combustion chamber. The fuel may be supplied quantity-controlled to the fuel distributor by a high-pressure pump.

The fuel-guiding component and the fuel injector, in particular the fuel connector, are not necessarily part of the connecting element according to the present invention. In particular, the connecting element according to the present invention may also be manufactured and marketed separately from the fuel-guiding component and the fuel injector.

The connecting element allows a targeted decoupling with a small installation space, it being possible to specify a desired rigidity of the decoupling, and at the same time, the required strength, in particular with regard to high system pressures, being ensured over the service life. A soft coupling of the fuel injector to the fuel-guiding component is possible, whereby a desirable target rigidity may preferably not be greater than 50 kN/mm. For this purpose, the base body has an elastically deformable design. Additionally or alternatively, the elasticity may be achieved via an elastically deformable decoupling element which is introduced into the base body, preferably in the area of the receiving chamber.

It is therefore advantageous that at least one decoupling element is provided, which in the installed state is situated between the fuel connector and the base body, and that the fuel connector is elastically supportable on the base body, at least in the radial direction, via the decoupling element. In particular, the desired target rigidity may be specified via a material of the decoupling element. This also allows adaptation to the particular application. In addition, simple installation may be achieved.

In this regard, it is also advantageous that the base body has an opening via which the fuel connector is insertable into the receiving chamber, and that the decoupling element is situated, at least in part, at the opening of the base body. This results in an advantageous design with regard to the required force transmission or the resulting lever arms. In addition, a combination with an elastically deformable base body is optionally implementable.

It is also advantageous that the base body has an inner side, that the decoupling element has an outer surface, and that the decoupling element with its outer surface rests flatly against a contact surface of the inner side of the base body. On the one hand, an advantageous force transmission, in particular a homogeneous distribution of the force on an elastic material of the decoupling element, may be achieved in this way. On the other hand, the required strength may thus be ensured over the service life, even under high system pressures.

Furthermore, it is advantageous that at least the contact surface of the inner side of the base body has a cylinder jacket shape. This results in advantages when the stress occurs mainly perpendicularly with respect to the contact surface, in particular in the radial direction.

However, it is also advantageous that at least the contact surface of the inner side of the base body has a concave profile. In this design, even forces having different directions, in particular having an axial component, may be reliably absorbed. This allows improved suspension in such cases.

In addition, the decoupling element may advantageously include at least one elastic layer and at least one protective layer, in particular a metallic protective layer, the at least one elastic layer and the at least one protective layer being layered in the radial direction. In particular, an elastic layer may be situated between two metallic protective layers. On the one hand, the contact between the fuel injector and the decoupling element, and between the base body and the decoupling element, may thus take place at the resistant protective layers. On the other hand, homogeneous stress on the elastic material of the elastic layer may also be achieved. In addition, the design of the contact surfaces, in particular on the fuel connector, may thus be simplified, since force is distributed over a larger cross-sectional area via the protective layer.

It is also advantageous that the decoupling element is made, at least essentially, of an elastic material which in the installed state is connected to the base body on the one hand, and to the fuel connector on the other hand. For example, a force-fit connection to the base body on the one hand and to the fuel connector on the other hand is achievable. In particular, the connection may be achieved by gluing or vulcanization of elastomeric material. In this design, the decoupling element may on the one hand achieve an advantageous suspension of the fuel injector. On the other hand, the decoupling element may additionally be used as a seal which completely or partially takes over a sealing function which may be necessary.

In another possible embodiment, it is advantageous that the base body includes an outer wall having at least one elastically deformable section, whereby the elastically deformable section may have the design of a corrugated bellows. This allows elastic deformation of the base body in the radial direction. In this design, an elastically deformable decoupling element is not necessarily required.

In addition, it is advantageous that the fuel connector has a radial rim, and that an elastic deformation of the decoupling element in the radial direction is limited by a mechanical stop of the rim of the fuel connector on the base body. The rim may be provided, for example, on an inlet-side end of the fuel connector, and may cooperate with the inner wall of the base body in order to form the stop. However, the rim of the fuel connector may also be situated at a distance from the inlet-side end.

### BRIEF DESCRIPTION OF THE DRAWINGS

FIG. 1 shows a connecting element and a fuel injector in a partial schematic sectional illustration corresponding to a first exemplary embodiment of the present invention.

FIG. 2 shows a connecting element and a fuel injector in a partial schematic sectional illustration corresponding to a second exemplary embodiment of the present invention.

FIG. 3 shows a connecting element and a fuel injector in a partial schematic sectional illustration corresponding to a third exemplary embodiment of the present invention.

FIG. 4 shows a connecting element and a fuel injector in a partial schematic sectional illustration corresponding to a fourth exemplary embodiment of the present invention.

FIG. 5 shows a fuel injection system which includes a connecting element in a partial schematic sectional illustration corresponding to a fifth exemplary embodiment of the present invention.

FIG. 6 shows a fuel injector which includes a connecting element in a partial schematic sectional illustration corresponding to a sixth exemplary embodiment of the present invention.

### DETAILED DESCRIPTION OF THE INVENTION

In the following description, with reference to the appended drawings, corresponding elements are provided with the same reference numerals.

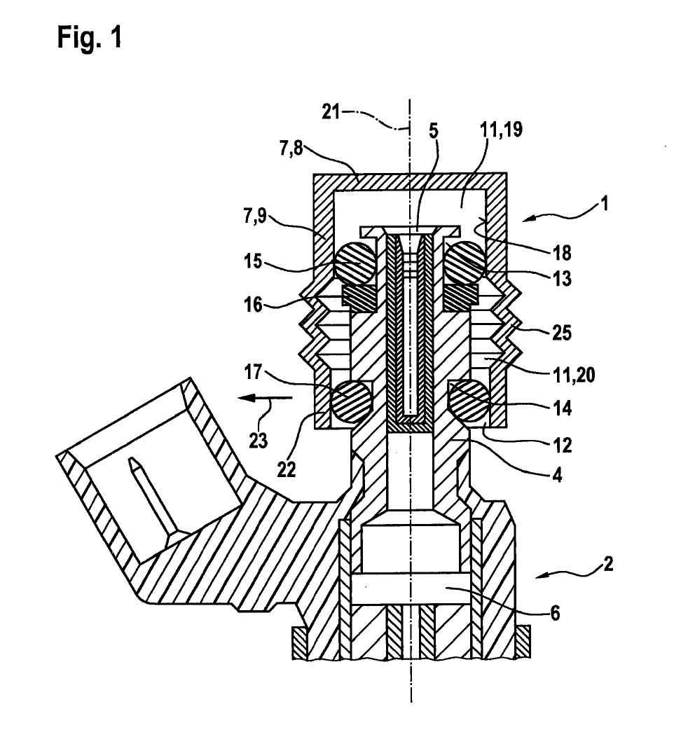

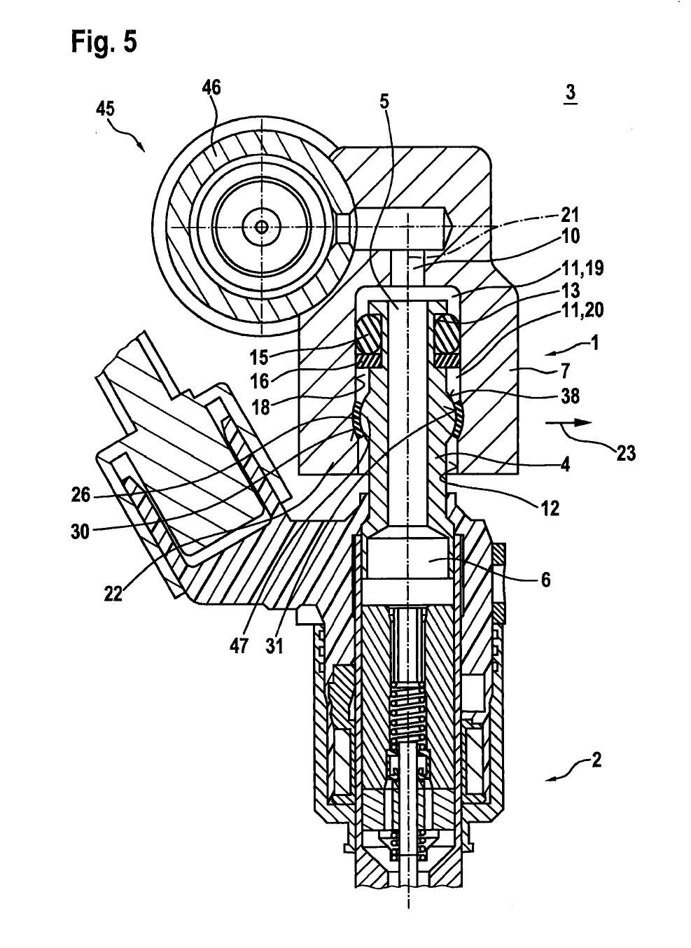

FIG. 1 shows a connecting element 1 and a fuel injector 2 of a fuel injection system 3 (FIG. 5) in a partial schematic sectional illustration corresponding to a first exemplary embodiment. Fuel injection system 3 may be used in particular for high-pressure injection in internal combustion engines. In particular, fuel injection system 3 may be used in mixture-compressing, spark ignition internal combustion engines. Connecting element 1 is particularly suited for such fuel injection systems 3.

Fuel injector 2 of fuel injection system 3 includes a fuel connector 4. During operation, fuel is guided into a fuel chamber 6 of fuel injector 2 at an inlet-side end 5 of fuel connector 4.

Connecting element 1 includes a base body 7 which has an upper part 8 and a tubular part 9. A suitable inflow bore 10 (FIG. 5) for guiding fuel into a receiving chamber 11 of base body 7 of connecting element 1 is provided in upper part 8.

In the installed state, fuel connector 4 is introduced into receiving chamber 11. Base body 7 has an opening 12 through which fuel connector 4 is introduced into receiving chamber 11 during installation.

In this exemplary embodiment, fuel connector 4 of fuel injector 2 has receptacles 13, 14 formed by recesses 13, 14. Receptacle 13 is used for accommodating a sealing element 15 and a support plate 16. Receptacle 14 is used for accommodating a sealing element 17 situated in the area of opening 12.

A portion 19 of receiving chamber 11 is sealed off from a portion 20 of receiving chamber 11 by sealing element 15, which cooperates on the one hand with fuel connector 4 and on the other hand with an inner side 18 of base body 7. In addition, portion 20 of receiving chamber 11 is sealed off from the surroundings by sealing element 17, which cooperates on the one hand with fuel connector 4 and on the other hand with inner side 18 of base body 7.

Receiving chamber 11 of base body 7 of connecting element 1 has an axis 21 along which fuel connector 4 is guided into receiving chamber 11 during installation. Thus, axis 21 coincides with the axis of fuel connector 4 in the installed state.

During operation, concussions or vibrations may cause, among other things, tilting or a radial movement of fuel connector 4. As a result, for example one end 22 of base body 7 at which opening 12 is provided may vibrate in a radial direction 23 and opposite thereto. Radial direction 23 is perpendicular to axis 21, and is illustrated as an example. Radial direction 23 is understood to be perpendicular to axis 21.

In this exemplary embodiment, tubular portion 9 of base body 7 is provided as outer wall 9. Outer wall 9 includes an elastically deformable section 25. Elastically deformable section 25 of outer wall 9 has the design of a corrugated bellows. A thickness of outer wall 9 is appropriately specified. An elastic deformation of base body 7 is made possible in this way. Fuel connector 4 is thus elastically supported on the base body in radial direction 23.

In this exemplary embodiment, it is thus ensured that fuel connector 4 is elastically supported on base body 7, at least in radial direction 23. Appropriate modifications are also encompassed in which the fuel connector is elastically supported not only in radial direction 23, but also partially along axis 21.

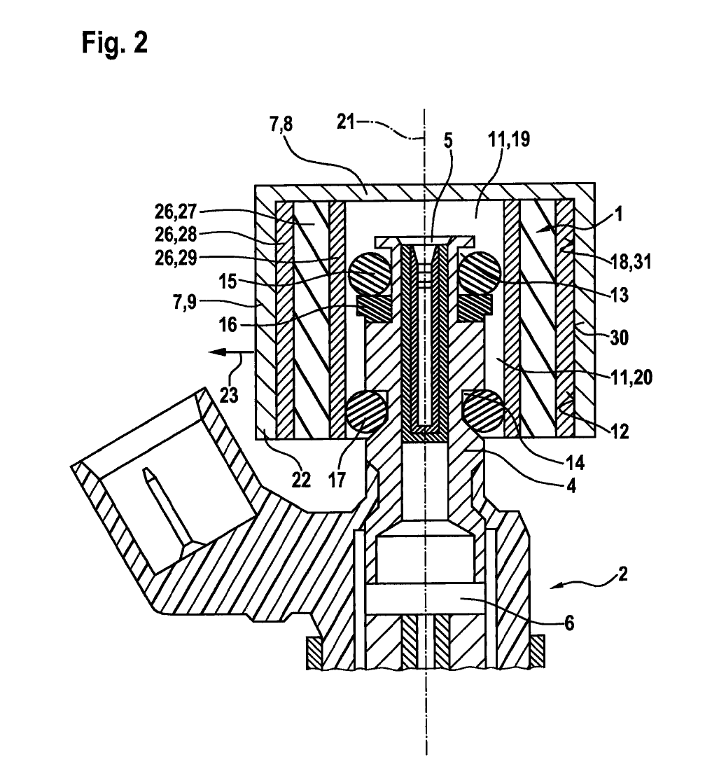

FIG. 2 shows connecting element 1 and fuel injector 2 in a partial schematic sectional illustration corresponding to a second exemplary embodiment. In this exemplary embodiment, a decoupling element 26 is provided which is situated between fuel connector 4 and base body 7. In this exemplary embodiment, decoupling element 26 includes an elastic layer 27 and metallic protective layers 28, 29. Elastic layer 27 and metallic protective layers 28, 29 each have a tube-shaped design, and are layered in radial direction 23. Viewed in radial direction 23, metallic protective layer 28 is situated outside elastic layer 27, and metallic protective layer 29 is situated inside elastic layer 27.

Metallic protective layer 28 of decoupling element 26 rests against inner side 18 of base body 7. Sealing elements 15, 17 rest against metallic protective layer 29 of decoupling element 26. This results, on the one hand, in flat contact of decoupling element 26 over its metallic protective layer 28 on inner side 18 of base body 7. On the other hand, forces which are transmitted to decoupling element 26 in a punctiform manner via sealing elements 15, 17 are uniformly introduced into elastic layer 27 with the aid of metallic protective layer 29. This reduces the mechanical load acting on elastic layer 27.

Decoupling element 26 has an outer surface 30, which in this exemplary embodiment is provided on metallic protective layer 28. Thus, decoupling element 26 rests flatly over its outer surface 30 against inner side 18 of base body 7. In this exemplary embodiment, a contact surface 31 of base body 7, against which decoupling element 26 rests flatly with its outer surface 30, is formed by entire inner side 18 of base body 7.

Outer surface 30 of decoupling element 26 and contact surface 31 of base body 7 each have a cylinder jacket shape in this exemplary embodiment.

Decoupling element 26 may be pressed into base body 7. In addition, decoupling element 26 may be joined to base body 7 by gluing. Other options for connecting decoupling element 26 to base body 7 are also conceivable. Elastic layer 27 may be made of an elastomer, for example. Metallic protective layers 28, 29 may be made of a steel, for example. However, in one appropriately modified embodiment, protective layers 28, 29 may also be made of nonmetallic materials.

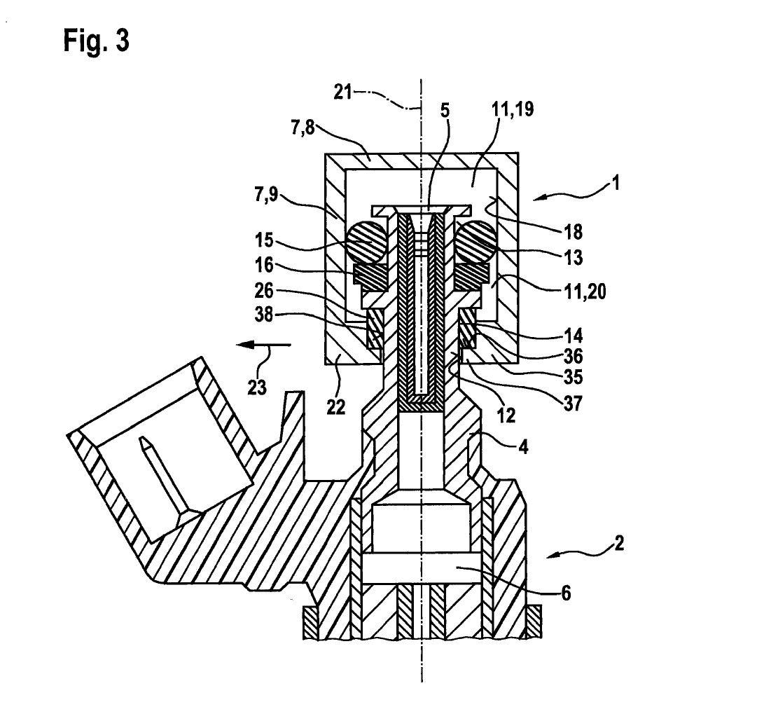

FIG. 3 shows a connecting element 1 and a fuel injector 2 in a partial schematic sectional illustration corresponding to a third exemplary embodiment. In this exemplary embodiment, base body 7 has a shoulder 35. Opening 12 is provided within shoulder 35. In addition, a step 36 is provided on shoulder 35 in the area of opening 12. Step 36 is provided on a projection 37 of shoulder 35.

In this exemplary embodiment, decoupling element 26 is situated on step 36 of shoulder 35. Decoupling element 26 annularly encloses an outer side 38 of fuel connector 4.

Elastic support of fuel connector 4 on base body 7 in radial direction 23 is thus ensured via decoupling element 26.

The decoupling thus acts only up to a certain adjusting force or a certain pressure level which acts on decoupling element 26. In this exemplary embodiment, the limitation is achieved in that projection 37 strikes outer side 38 of fuel connector 4 at a maximum adjusting movement or oscillation amplitude. A maximum load which may act on decoupling element 26 is thus appropriately limited.

This embodiment is particularly advantageous in applications in which a decoupling is desired primarily during a no-load operation. Since the decoupling must be effective in particular at no-load speeds, this design feature is particularly meaningful when an operating pressure in no-load operation is lower than at higher speeds.

In this exemplary embodiment, the connection of fuel connector 4 to connecting element 1 may be achieved by a bayonet lock, for example. For this purpose, connecting element 1 and/or fuel connector 4 is/are not provided rotationally symmetrically with respect to axis 21, but, rather, is/are interrupted in the circumferential direction. The installation may then take place via a push-turn motion.

However, in one modified specific embodiment, installation may also be possible by a multi-part design of base body 7. A rotationally symmetrical design of connecting element 1 and of fuel connector 4 is then possible.

Thus, in this exemplary embodiment, an elastic deformation of decoupling element 26 in radial direction 23 may be limited by a mechanical stop of projection 37 of base body 7 on outer side 38 of fuel connector 4.

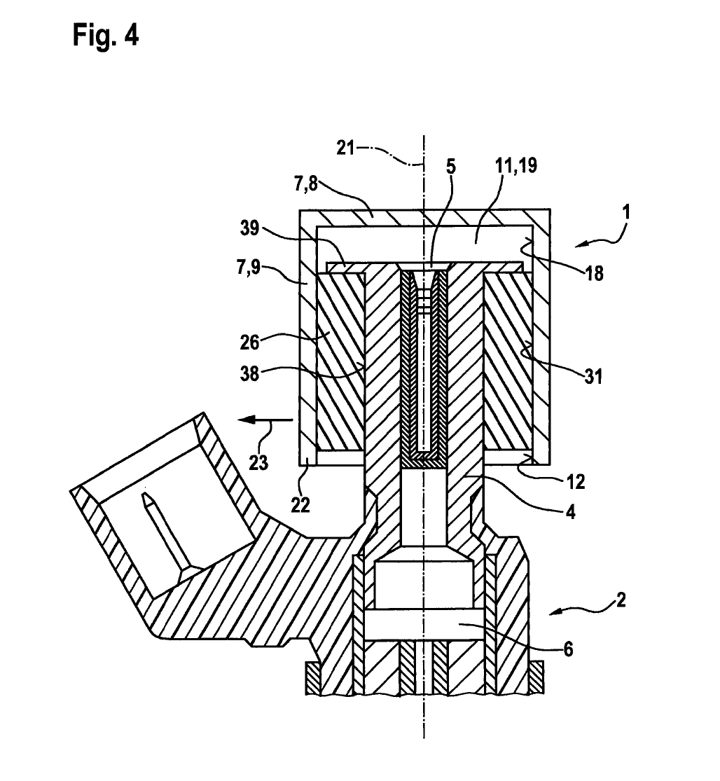

FIG. 4 shows connecting element 1 and fuel injector 2 in a partial schematic sectional illustration corresponding to a fourth exemplary embodiment. In this exemplary embodiment, decoupling element 26 is made of an elastomer, for example. Decoupling element 26 on the one hand rests flatly against outer side 38 of fuel connector 4. On the other hand, decoupling element 26 rests flatly against a contact surface 31 of inner side 18 of base body 7. In this exemplary embodiment, contact surface 31 is an actual part of inner side 18 which does not extend over entire inner side 18. The connection of decoupling element 26 to fuel connector 4 and also to base body 7 may have a force-fit design. In particular, gluing or vulcanization of elastomeric material of decoupling element 26 may be used for the connection. Decoupling element 26 may thus additionally ensure a sealing function which seals off portion 19 of receiving chamber 11 from the surroundings which adjoin opening 12.

In addition, in this exemplary embodiment, inlet-side end 5 of fuel connector 4 includes a radial rim 39 which extends in radial direction 23. Radial rim 39 has a disk-shaped design. A limitation of the force acting on decoupling element 26 or the deformation of decoupling element 26 is achieved by radial rim 39. The elastic deformation of decoupling element 26 is limited in radial direction 23 by a mechanical stop of radial rim 39 of fuel connector 4 against inner side 18 of base body 7.

FIG. 5 shows a fuel injection system 3 which includes a connecting element 1 and a fuel injector 2 in a partial schematic sectional illustration corresponding to a fifth exemplary embodiment. Fuel injection system 3 includes a fuel-guiding component 45. In this exemplary embodiment, fuel-guiding component 45 is designed as a fuel distributor 45, in particular a fuel rail 45. Connecting element 1 is mounted on fuel distributor 45. Connecting element 1 may be suitably connected to a tubular base body 46 of fuel distributor 45. Connecting element 1 may also be an integral part of fuel distributor 45. Multiple such connecting elements 1 which are each used for connection to a fuel injector 2 are preferably situated on fuel distributor 45.

In this exemplary embodiment, a bulge 47 is formed on fuel connector 4. Bulge 47 is a semicircular bead 47. Bulge 47 of fuel connector 4 has a design with a convex profile.

Accordingly, a contact surface 31 of base body 7 has a design with a concave profile in the area of bulge 47 of installed fuel connector 4. In this exemplary embodiment, decoupling element 26 is situated between bulge 47 of fuel connector 4 and concave contact surface 31 of base body 7. Decoupling element 26 thus has a correspondingly curved design. In this exemplary embodiment, decoupling element 26 is made of an elastomer. In one modified specific embodiment, decoupling element 26 may also have a multi-layered design, for example as described with reference to FIG. 2.

In this embodiment, elastic support of fuel connector 4 on base body 7 in the radial direction is made possible via decoupling element 26. In addition, elastic support along axis 21 is made possible. An advantageous suspension of fuel injector 2 is thus achieved.

Base body 7 and fuel connector 4 may have a design that is interrupted in the circumferential direction, not rotationally symmetrical. Installation via a push-turn motion is thus possible. The connection may thus be designed in particular as a bayonet lock.

In this embodiment, bearing tolerances may be compensated for very well, since fuel injector 2 may be rotatably supported in its suspension on connecting element 1.

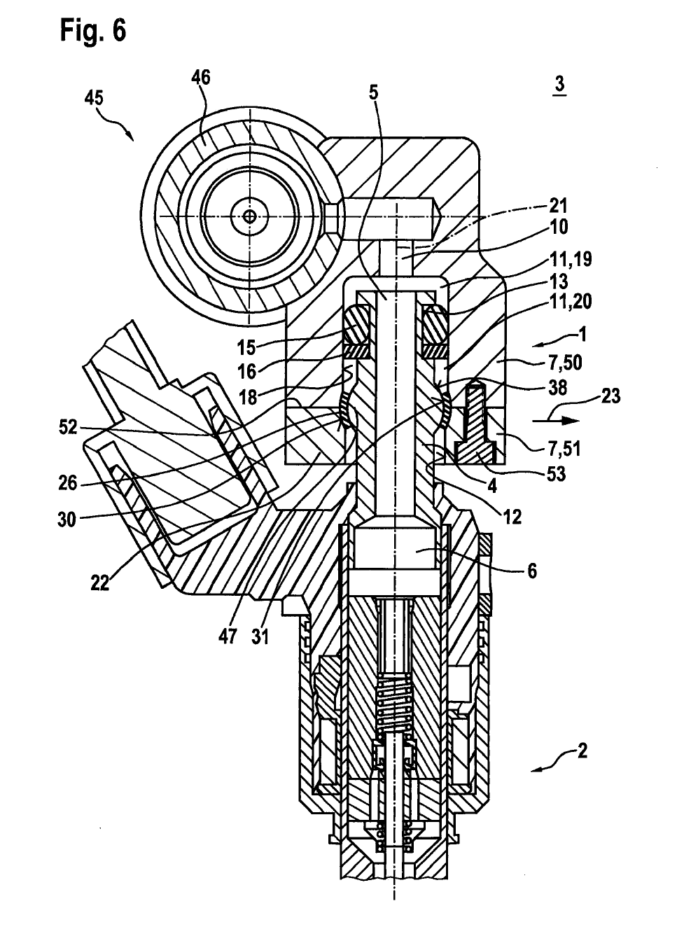

FIG. 6 shows a fuel injection system 3 which includes a connecting element 1 and a fuel injector 2 in a partial schematic sectional illustration corresponding to a sixth exemplary embodiment. In this exemplary embodiment, base body 7 of connecting element 1 has a multi-part design. In particular, in this exemplary embodiment, portions 50, 51 of base body 7 are illustrated which are joined together at a connecting surface 52. During installation, portion 51 of the base body may initially be detached from portion 50 in order to attach decoupling element 26. A screw connection via one or multiple screw elements 53 is then possible. Fuel connector 4 and base body 7 may thus have a rotationally symmetrical design in the area of fuel connector 4, in particular of receiving chamber 11.

However, the connection of portions 50, 51 of base body 7 may also take place in some other way.

1-11. (canceled)

12. A connecting element of a fuel injection system for connecting a fuel injector to a fuel-guiding component, comprising:
a base body in which a receiving chamber for a fuel connector of the fuel injector is provided, wherein the fuel connector, which is at least partially situated in the receiving chamber, is supported at least indirectly on the base body, and wherein the fuel connector is elastically supported on the base body at least in a radial direction.

13. The connecting element as recited in claim 12, further comprising:
at least one decoupling element which, in the installed state, is situated between the fuel connector and the base body, wherein the fuel connector is elastically supported on the base body, at least in the radial direction, via the decoupling element.

14. The connecting element as recited in claim 13, wherein the base body has an opening via which the fuel connector is inserted into the receiving chamber, and the decoupling element is situated, at least in part, at the opening of the base body.

15. The connecting element as recited in claim 13, wherein:
the base body has an inner side;
the decoupling element has an outer surface; and
the outer surface of the decoupling element rests flatly against a contact surface of the inner side of the base body.

16. The connecting element as recited in claim 15, wherein at least the contact surface of the inner side of the base body has one of a cylinder jacket shape or a concave profile.

17. The connecting element as recited in claim 13, wherein the decoupling element includes at least one elastic layer and at least one protective layer, and wherein the at least one elastic layer and the at least one protective layer are layered in the radial direction.

18. The connecting element as recited in claim 13, wherein the decoupling element is made of an elastic material which in the installed state is at least indirectly connected to the base body and the fuel connector.

19. The connecting element as recited in claim 18, wherein the base body has an outer wall which includes at least one elastically deformable section.

20. The connecting element as recited in claim 19, wherein the elastically deformable section is shaped as a corrugated bellows.

21. A fuel injection system for a mixture-compressing, spark ignition internal combustion engines, comprising:
at least one fuel-guiding component;
at least one fuel injector; and
at least one connecting element for connecting the fuel injector to the fuel-guiding component, wherein the connecting element includes:
a base body in which a receiving chamber for a fuel connector of the fuel injector is provided, wherein the fuel connector, which is at least partially situated in the receiving chamber, is supported at least indirectly on the base body, and wherein the fuel connector is elastically supported on the base body at least in a radial direction.

22. The fuel injection system as recited in claim 21, wherein the fuel connector has a radial rim, and an elastic deformation of the decoupling element in the radial direction is limited by a mechanical stop of the rim of the fuel connector on the base body.
